(19) United States
(12) Patent Application Publication
(10) Pub. No.: US 2024/0322587 A1
(43) Pub. Date: Sep. 26, 2024

(54) BATTERY CHARGING SYSTEMS AND METHODS

(71) Applicant: Briggs & Stratton, LLC, Wauwatosa, WI (US)

(72) Inventors: Michael Gigot, Greendale, WI (US); Mark Noller, Wauwatosa, WI (US); Michael D. Marshall, Jackson, WI (US); Jonathan M. Tripi, Oconomowoc, WI (US)

(73) Assignee: Briggs & Stratton, LLC, Wauwatosa, WI (US)

(21) Appl. No.: 18/290,057

(22) PCT Filed: May 13, 2022
(86) PCT No.: PCT/IB2022/054492

§ 371 Date: Nov. 9, 2023

Related U.S. Application Data
(60) Provisional application No. 63/188,810, filed on May 14, 2021.

(51) Int. Cl. H02J 7/00; H01M 10/42; H01M 10/46; H01M 50/204

(52) U.S. Cl. CPC H02J 7/007182; H01M 10/425; H01M 10/46; H01M 50/204; H02J 7/00032; H02J 7/0013; H02J 7/0047; H02J 7/00714; H02J 7/007194; H01M 2010/4271

(57) ABSTRACT

A battery pack assembly which includes a battery pack. The battery pack includes a housing receiving a plurality of rechargeable battery cells, a battery management system (BMS) in communication with the rechargeable battery cells and configured to monitor one or more operating characteristics of the rechargeable battery cells, a plurality of terminals to transmit electrical power between the rechargeable battery cells and a piece of equipment coupled with the plurality of terminals, a communication interface in communication with BMS and configured to transmit the operating characteristics of the rechargeable battery cells over a communication protocol and receive information from the piece of equipment coupled with the plurality of terminals over the communication protocol.

### CROSS-REFERENCE TO RELATED APPLICATION

This application claims priority to U.S. Provisional Patent Application No. 63/188,810, filed May 14, 2021, the content of which is hereby incorporated by reference in its entirety.

### BACKGROUND

The present disclosure generally relates to the field of batteries for use in indoor and outdoor power equipment, and in particular, to charging systems and methods for batteries that are used in indoor and outdoor power equipment.

### SUMMARY

One embodiment of the disclosure relates to a battery pack assembly. The battery pack assembly includes a battery pack. The battery pack includes a housing, rechargeable battery cells, a battery management system (BMS), a plurality of terminals, and a communication interface. The housing receives the plurality of rechargeable battery cells. The BMS is in communication with the rechargeable battery cells and is configured to monitor one or more operating characteristics of the rechargeable battery cells. The plurality of terminals are in electrical communication with the rechargeable battery cells to transmit electrical power between the rechargeable battery cells and a piece of equipment coupled with the plurality of terminals. The communication interface is in communication with the battery management system and is configured to transmit the operating characteristics of the rechargeable battery cells over a communication protocol and receive information from the piece of equipment coupled with the plurality of terminals over the communication protocol. The battery management system is configured to determine a current limit of the battery pack based upon a maximum cell voltage of the rechargeable battery cells and adjust an input current of electrical power through the plurality of terminals to the rechargeable battery cells to adjust the current received by the battery pack toward the current limit.

### BRIEF DESCRIPTION OF THE DRAWINGS

The disclosure will become more fully understood from the following detailed description, taken in conjunction with the accompanying figures, in which:

FIG. 1 is a perspective view of a battery assembly, according to an exemplary embodiment;

FIG. 2 is a schematic view of a parallel battery system with battery packs connected in a parallel configuration on a bus, according to an exemplary embodiment;

FIGS. 3A-3B are flowcharts of a process for operating a battery pack, such as a battery pack from the battery assembly of FIG. 1, when the battery pack is connected to the bus in the parallel configuration as shown in FIG. 2;

FIG. 4 is a flowchart of a process that can be used to control the parallel battery system of FIG. 2;

FIG. 5A is a flowchart of a communication process that can be used within the parallel battery system of FIG. 2; and

FIG. 5B is a flowchart of an address claiming process that can be performed by each BMS within the parallel battery system of FIG. 2.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring to the figures generally, the battery pack assemblies and chargers described herein are configured to communicate with one another to provide optimized and effective charging. The chargers provide a control interface that can communicate between one or more battery packs connected in a parallel configuration on the charger to complete an efficient and controlled charging process for batteries of different sizes and/or charge levels. The battery management system associated with one of the battery packs may be configured as a primary controller that provides information and control for the whole parallel battery system in order to balance the charge states of each battery coupled with a common bus. Each BMS is capable of functioning as either the primary controller or a secondary (or subservient) controller. Accordingly, if there is a loss of communication between the battery management systems associated with the rest of the battery packs and/or the BMS currently designated as the primary controller, another BMS can be reconfigured as the primary controller in real-time. In traditional systems, such a loss in communication regarding the charge state of batteries on a common bus may lead to damage or complete destruction of the battery assembly. The battery packs and assemblies disclosed herein are robust to multiple connections and disconnections between any number of battery packs and chargers within a battery assembly so that if communication with the primary controller is lost, a new battery management system may be designated as the primary controller and the battery assembly can continue to function as expected.

Parallel battery pack configurations are often used in battery assemblies for various types of indoor and outdoor power equipment, as well as with portable jobsite equipment and military vehicle applications. Outdoor power equipment includes lawn mowers, riding tractors, snow throwers, pressure washers, tillers, log splitters, zero-turn radius mowers, walk-behind mowers, riding mowers, stand-on mowers, pavement surface preparation devices, industrial vehicles such as forklifts, utility vehicles, commercial turf equipment such as blowers, vacuums, debris loaders, overseeders, power rakes, aerators, sod cutters, brush mowers, portable generators, etc. Indoor power equipment includes floor sanders, floor buffers and polishers, vacuums, etc. Portable jobsite equipment includes portable light towers, mobile industrial heaters, and portable light stands. Military vehicle applications include installing the battery system on All-Terrain Vehicles (ATVs), Utility Task Vehicles (UTVs), and Light Electric Vehicle (LEV) applications. The parallel arrangement of battery packs is particularly useful and common in situations where the battery packs do not have predetermined or assigned equipment. Because the same battery packs may be used to power several different pieces of power equipment, the ability to determine the presence of other voltage sources along the battery busbar becomes particularly useful.

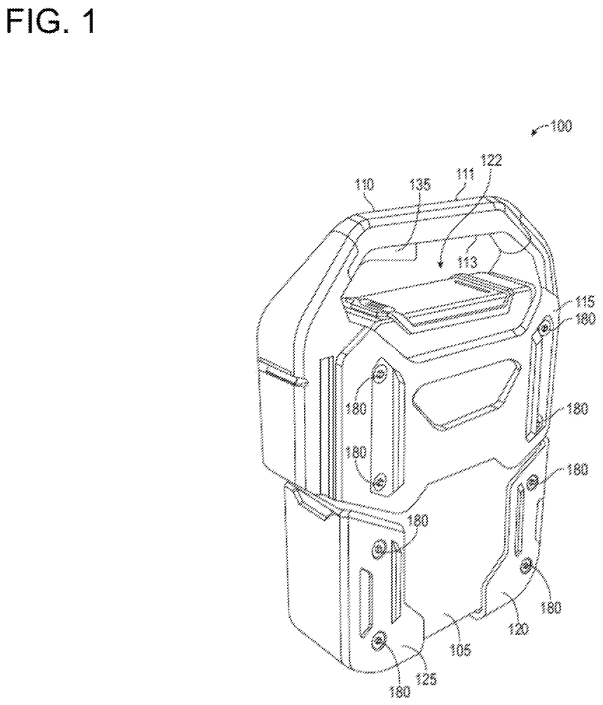

Referring to FIG. 1, a battery assembly 100 is shown, according to an exemplary embodiment. The battery assembly 100 is configured to be coupled with an equipment interface (e.g., removably mounted on a piece of equipment) or inserted (e.g., dropped, lowered, placed) into a receiver integrated with a piece of equipment and/or a charging station to supply or receive electrical power. The battery assembly 100 can be installed into a piece of equipment vertically, horizontally, and at any angle. The battery assembly 100 includes a battery pack 105 and optionally, one or more modular portions as described below. The battery pack 105 is a Lithium-ion battery that supports one or more rechargeable lithium-ion battery cells. However, other battery types are contemplated, such as nickel-cadmium (NiCD), lead-acid, nickel-metal hydride (NiMH), lithium polymer, etc. The battery assembly 100 yields a voltage of approximately 48 Volts (V) and 1400 Watt-hours (Wh) of capacity. It is contemplated that battery assemblies of other sizes may also be used. The battery assembly 100 is capable of approximately 2,000 charge/discharge cycles, approximately 5,000 W continuous power (13 Amps (A) per cell), 9,000 W peak power (25 A per cell), and 14,000 W instantaneous power (40 A per cell). The battery assembly 100 in total weighs less than approximately twenty-five pounds, allowing for ease of portability, removal, and replacement. The battery assembly 100 is also hot-swappable meaning that a drained battery assembly 100 can be exchanged for a new battery assembly 100 without completely powering down connected equipment. As such, downtime between battery assembly 100 exchanges is eliminated.

The battery assembly 100 can be removed by an operator from a piece of equipment without the use of tools. The battery assembly 100 can also be recharged using a charging station, as described further herein. Accordingly, the operator may use a second rechargeable battery having a sufficient charge to power equipment while allowing the first battery to recharge. In addition, the battery assembly 100 can be used on various types of equipment including indoor, outdoor, and portable jobsite equipment. Due to its uniformity across equipment, the battery assembly 100 can also be used as part of a rental system, where rental companies who traditionally rent out pieces of equipment can also rent the battery assembly 100 to be used on such equipment. An operator can rent a battery assembly 100 to use on various types of equipment or vehicles the operator may own and/or rent and then return the battery assembly 100 to be used by other operators on an as-needed basis. Furthermore, multiple battery assemblies 100 may be used in conjunction with each other to provide sufficient power to equipment that may require more than a single battery assembly.

The battery assembly 100 is configured to be selectively and electrically coupled to a piece of equipment and/or a charging station. The piece of equipment or charging station includes a receiver having electrical terminals that are selectively and electrically coupled to the battery assembly 100 without the use of tools. For example, an operator may both insert (and electrically couple) and remove (and electrically decouple) the battery assembly 100 from a piece of equipment (e.g., from terminals of a receiver) without the use of tools. The equipment interface and/or receiver may include a planar mounting surface having at least one aperture for receiving a threaded fastener and the equipment interface and/or receiver may be coupled to the piece of equipment via one or more threaded fasteners.

Still referring to FIG. 1, the battery assembly 100 further includes an upper modular portion 115 coupled to the upper portion of the battery pack 105, and lower modular portions 120, 125 coupled to a lower portion of the battery pack 105 on each of the left and right sides. The upper modular portion 115 and lower modular portions 120, 125 are coupled to the battery pack 105 using fasteners 180 (e.g., bolts, screws). The lower modular portions 120, 125 provide protection to the battery pack 105 and act to absorb or limit the amount of force the battery pack 105 endures by dropping, etc. The upper modular portion 115 and lower modular portions 120, 125 are exchangeable and customizable such that an operator or original equipment manufacturer may choose a different design and/or color based on the type or make and model of the equipment with which the battery assembly 100 is to be used. The upper modular portion 115 including the handle 110 and the lower modular portions 120, 125 can be removed from the battery pack 105. As such, in some embodiments, the battery assembly 100 may not include the upper modular portion 115 and/or lower modular portions 120, 125 and may be permanently mounted to a piece of equipment. The battery assembly 100 can be removed by an operator by grasping the handle 110 of each battery assembly 100, unlocking the battery assembly 100 from the slot by moving the release mechanism on the handle 110 (e.g., movable member 135), and pulling upward and outward until fully removed from the slot. The handle 110 includes an outer surface 111 and an inner surface 113 positioned nearer the battery pack 105 than the outer surface 111. The inner surface 113 includes a release mechanism or movable member 135 configured to be operable by the operator to unlock and decouple the battery assembly 100 from a charging station and/or a piece of equipment. When depressed, the movable member 135 moves inward toward the inner surface 113 and unlocks the battery assembly 100 out of engagement with a respective feature on a charging station and/or piece of equipment. In this way, when an operator grasps the handle 110, the operator can, at the same time and with the same hand, easily depress the movable member 135 to disengage the battery assembly 100 from a piece of equipment or charging station.

The battery pack 105 further includes a user interface 122 configured to display various status and fault indications of the battery assembly 100 and/or the associated equipment. The user interface 122 uses light-emitting diodes (LEDs), liquid crystal display, etc., to display various colors or other indications. The user interface 122 can provide battery charge status, and can blink or flash battery fault codes. Additionally, the user interface 122 can provide information about the battery assembly 100 including condition, tool specific data, usage data, faults, customization settings, etc. For example, battery indications may include, but are not limited to, charge status, faults, battery health, battery life, capacity, rental time, battery mode, unique battery identifier, link systems, etc. The user interface 122 can be a customized version of a user interface tailored to a specific tool, use, or operator.

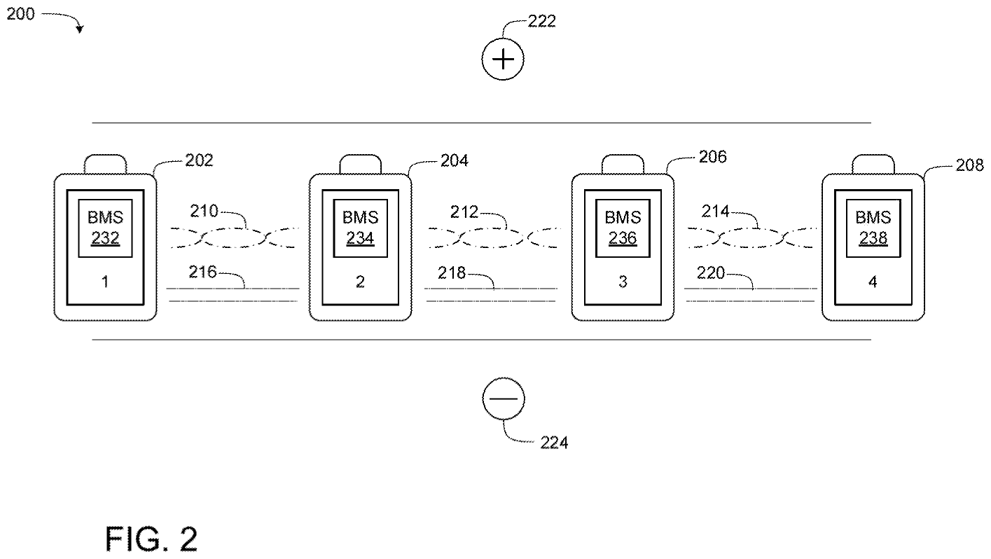

Referring to FIG. 2, a parallel battery system 200 with battery packs connected in a parallel configuration is shown, according to an exemplary embodiment. As depicted in FIG. 2, the battery system 200 has four different battery packs 202, 204, 206, 208 connected together in parallel, with each positive terminal of the battery packs 202, 204, 206, 208 connecting to positive terminal bus 222 and each negative terminal of the battery packs 202, 204, 206, 208 connecting to negative terminal bus 224. Various different battery pack arrangements can be used as well. For example, the battery system 200 can have only a single battery pack 202 (e.g., the battery pack 100), or can have some combination of the battery pack 204, the battery pack 206, and the battery pack 208 connected in a parallel configuration. In other examples, the battery system 200 has more than four battery packs connected in parallel, such as sixteen or more battery packs. The battery packs 202, 204, 206, 208 can have different output ratings and capacities, or can have similar or the same ratings and capacities. The negative terminal bus 224 is connected to a common ground so that the battery pack 202, the battery pack 204, the battery pack 206, and the battery pack 208 are all grounded together. In some embodiments, the battery pack 202 and the other battery packs in system 200 are Lithium-ion batteries, like the battery pack 105. In other embodiments, the battery pack 202 and the other battery packs in system 200 are different battery types (e.g., lead-acid, lithium polymer, nickel-cadmium, etc.).

Each battery pack 202, 204, 206, and 208 in the battery system 200 is connected to a 29-bit Controller Area Network bus (CANbus) network for sending and receiving communications from other battery packs within the parallel battery system 200. A CANbus link 210, a CANbus link 212, and a CANbus link 214 are intact to permit network communications between the battery packs 202, 204, 206, 208 of the battery system 200. Alternatively, other digital communication protocols may be used instead of CANbus communications. For example, the digital communication protocol may use one or more of I2C, I2S, Serial, SPI, Ethernet, 1-Wire, etc. In still other examples, wireless communication protocols can be used by the battery packs 202, 204, 206, 208, including Wi-Fi, Bluetooth, Zigbee, mesh network, etc. Additionally, each pack 202, 204, 206, 208 in the battery system 200 may be connected to an identical charge enable signal and an identical discharge enable signal as every other battery pack. For example, discharge enable signal 216 is connected to discharge enable signal 218 and discharge enable signal 220.

In some embodiments, each of the battery packs 202, 204, 206, and 208 have a battery management system (BMS) 232, 234, 236, 238. The BMS facilitates communication between each of the battery packs connected in the parallel configuration. In some embodiments, the battery management systems 232, 234, 236, and 238 may communicate with each other and a charger station (e.g., with a controller of the charger station, etc.) via physical serial interface (e.g., controller area network (CAN) or RS-485) or an over-the-air (OTA) interface (e.g., Bluetooth low energy (BLE), near-field communication (NFC), etc.) The battery packs 202, 204, 206, 208 are configured to communicate various different operational parameters (charge state, charge limit, current charge, etc.) and/or commands to one another via each BMS 232, 234, 236, 238 using one or more of the communication protocols discussed above.

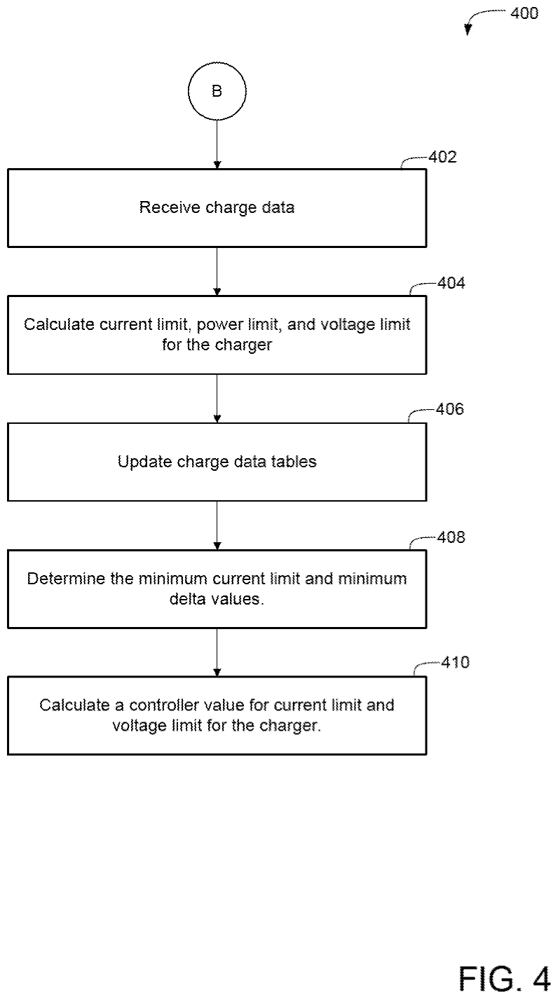

The parallel battery system 200 can balance the state of charge and ensure that each battery pack 202, 204, 206, 208 operates within certain voltage and current limits in order to ensure effective use of the battery system. To help control voltage and current limits of the parallel battery system 200, the BMS of 232, 234, 236, 238 of one of the battery packs 202, 204, 206, 208 can be assigned as the “primary controller.” The primary controller is configured to operate in direct communication with the equipment (e.g., the charger, other power equipment including an equipment interface, etc.) and each of the other battery packs 202, 204, 206, 208 to effectively control operation of each of the remaining battery packs 202, 204, 206, 208 that are coupled with the equipment. Accordingly, the primary controller is configured to communicate commands, operational parameters, and other information to and from the equipment, which can allow for precise parallel battery system 200 control. In some examples, each of the BMS 232, 234, 236, 238 can be configured to operate as the primary controller as well as a secondary or subservient controller, and specific control logic is used to determine which of the BMS 232, 234, 236, 238 will assume the role of primary controller within the parallel battery system 200. The method for determining battery priority is explained in additional detail below with respect to FIG. 4.

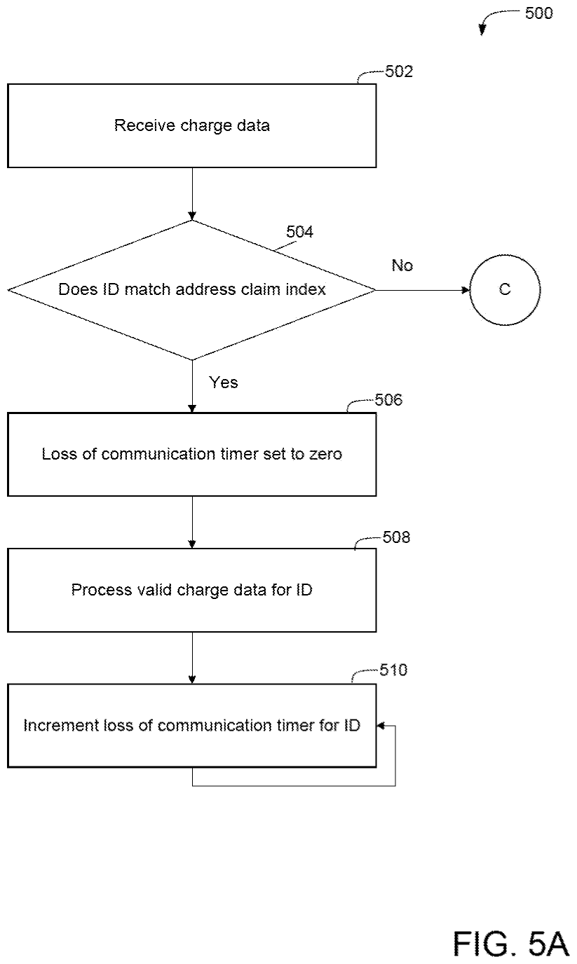

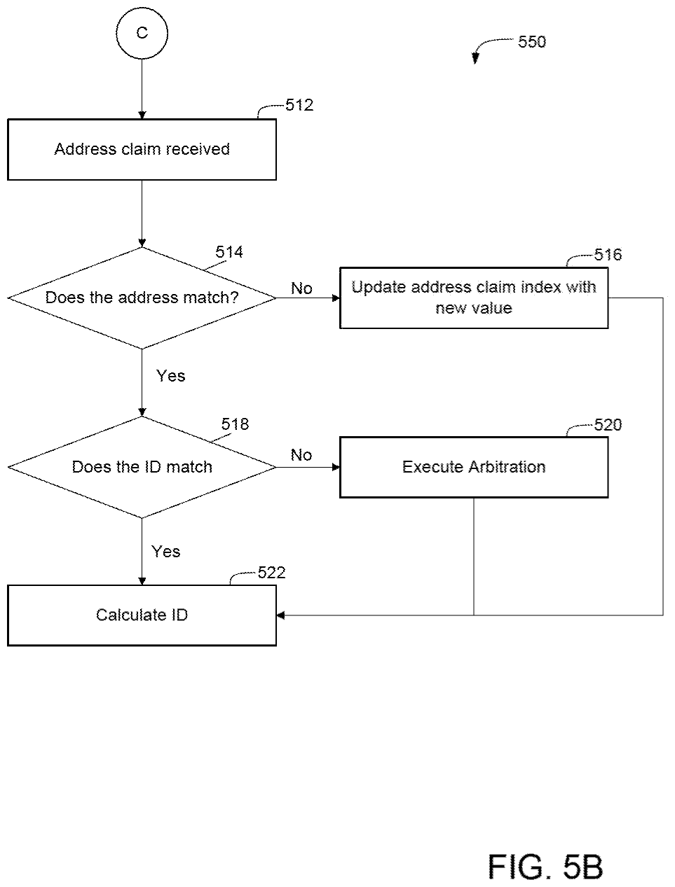

In some embodiments, each of the battery packs 202, 204, 206, 208 have individual identifying information (e.g., serial number, ECU specific information, manufacture information, etc.). The individual identifying information can be stored within or otherwise accessible by the BMS 232, 234, 236, 238 associated with the battery pack 202, 204, 206, 208 and used by the equipment and/or the primary controller to determine certain features of the battery pack 202, 204, 206, 208, including charge capacity, voltage limits, etc. The identity and features of the battery pack 202, 204, 206, 208 can be used to operate the parallel battery system 200 effectively, as explained in additional detail below. The identifying information can also be used to determine priority for which battery pack 202, 204, 206, 208 should support the BMS considered to be the primary controller. In some examples, each battery pack 202, 204, 206, 208 within the parallel battery system 200 is configured to store identifying information about each battery present on the equipment. When a battery pack (e.g., 202, 204, 206, and 208) wants to join the battery busbar (e.g., through the positive terminal bus and negative terminal bus) of the parallel battery system 200, this identifying information is communicated so that each battery pack and its respective BMS can go through an address claiming process before joining the battery busbar. The address claiming process effectively determines which BMS 232, 234, 236, 238 should serve as the primary controller in the system, which will then determine which BMS 232, 234, 236, 238 will communicate directly with a controller of the charger and/or other power equipment supporting the battery packs. The address claiming process is described in more detail with respect to FIG. 5B. Each of the BMS 232, 234, 236, 238 also have an ID calculated through the address claiming process. In some embodiments, if two battery packs and their respective battery management systems have the same identifying information, then a conflict resolution action is taken. The conflict resolution process is described in more detail with respect to FIG. 5B.

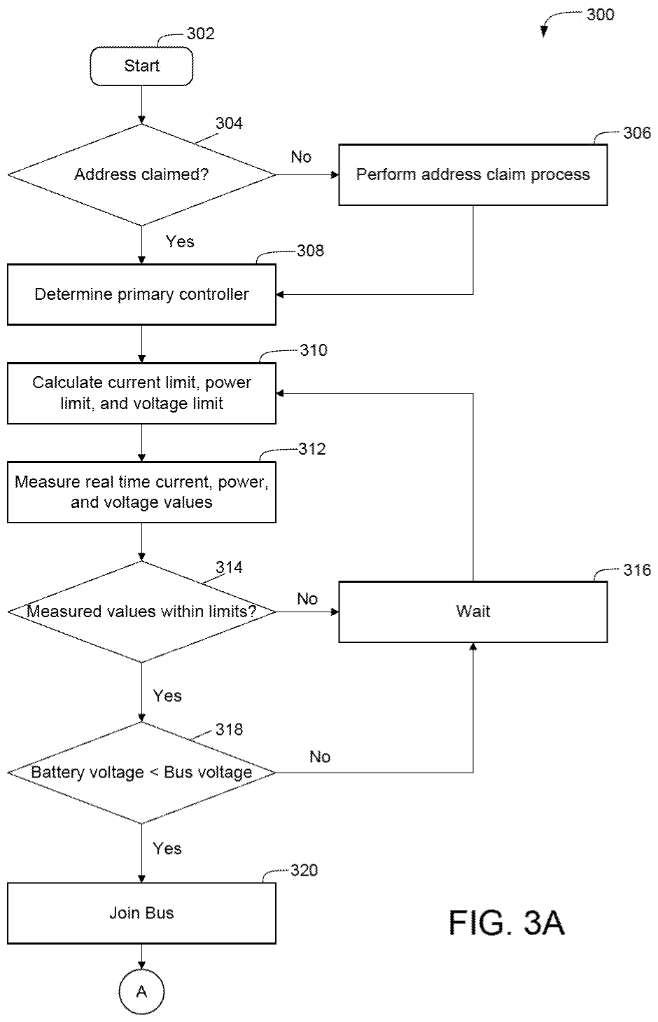

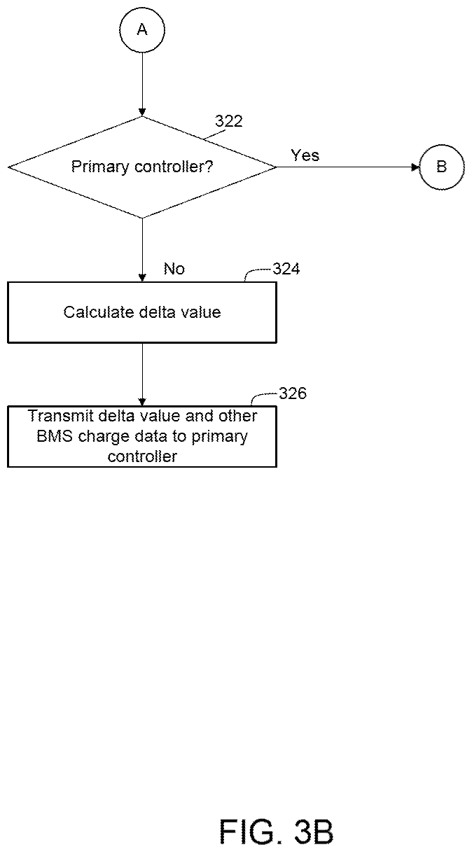

Referring now to FIG. 3A and FIG. 3B, a process 300 for operating each individual BMS 232, 234, 236, 238 of the parallel battery system 200 is shown. The battery management systems 232, 234, 236, 238 are hereinafter referred to generally as “the BMS” and whichever BMS (which can be any of the BMS 232, 234, 236, or 238) is designated as the primary controller is herein after referred to as “the primary controller BMS” for clarity.

The process 300 begins when a battery pack 202, 204, 206, 208 attempts to join a battery bus. For example, the process 300 can begin when a battery pack 202, 204, 206, 208 is physically coupled with a piece of equipment (e.g., a charger). Before joining the battery pack with the battery bus, and at step 302, the equipment and/or primary controller within the system determines if the joining battery pack BMS has claimed an address. As explained above, the address is a unique identifying code that can be assigned to the battery pack to operate within the equipment. The address can be based on different information about the battery pack, including manufacturer, date, battery type, battery capacity, a serial number of the battery, etc. If the BMS does not have an address claimed, then the BMS performs an address claim process at step 306 before proceeding with the rest of the process 300. The address claim process 306 effectively works to provide a unique identifying value to each battery pack within the system, which can then be used for further communication and control processes. In some examples, the BMS with the lowest address value is assigned to serve as the primary controller BMS.

Once the BMS has claimed an address at step 306, the BMS proceeds to determine if it is the primary controller or not. As mentioned above, any BMS within the parallel battery system 200 has the capability to become the primary controller for the parallel battery system 200. In some embodiments, the BMS in the lowest ID position is designated to become the primary controller BMS. In yet other embodiments, the BMS in the highest ID position becomes the primary controller BMS. For example, if the BMS 232 has an ID of 1, BMS 234 has an ID of 2, BMS 236 has an ID of 3, and BMS 238 has an ID of 4, the BMS 232 would be assigned the role of the primary controller BMS because it has the lowest ID position of 1.

At step 310, the BMS calculates a current limit, a power limit, and a voltage limit for the battery pack using the BMS. In some examples, the quantities are based upon the battery type or size, and are stored within the BMS. In other examples, the BMS actively monitors the rechargeable battery cells within the battery to determine these operational characteristics, or uses a combination of measured and stored values. To ensure the effective and efficient operation of the battery pack, the BMS associated with the battery pack may be configured to set operational limits for parameters associated with the battery pack such as the current limit, a power limit, and a voltage limit. In some embodiments, the BMS may use either a proportional, proportional integral (PI), proportional derivative (PD), or proportional integral derivative (PID) control loop to determine the current limit of the BMS based on a maximum cell voltage. The control loop then controls the current limit to reach and hold the maximum cell voltage up to the maximum cell voltage limit.

At step 312, the BMS measures a real time current, power, and voltage value associated with its corresponding battery pack. The BMS can perform these processes by directly monitoring the one or more rechargeable cells within the battery pack. At step 314, the BMS then determines if the measured values measured at step 312 are within the current limit, power limit, and voltage limits for the battery pack that were determined or otherwise identified at step 310. If the measured values are not within the aforementioned limits, the BMS waits for a predetermined amount of time (e.g., 5 seconds, 10 seconds, 1 minute, etc.) before restarting the process 300 at step 310. If the measured values are within the limits determined at step 310, then the BMS determines if the measured voltage is less than a predetermined value (e.g., a value associated with a battery busbar voltage) at step 318. If the measured value is greater than the predetermined value, the BMS waits a predetermined time and then restarts the process 300 at step 310. If the measured value is less than the predetermined value, the BMS proceeds to join the battery busbar at step 320, where it can then receive and/or transmit electrical power.

Referring now to FIG. 3B, the process 300 continues once the battery pack has joined the battery busbar. After joining the battery busbar, the BMS determines whether it is a primary controller or not. The BMS determines whether it is a primary controller or whether it should be a primary controller by comparing its stored address against other addresses that are present on the battery busbar. If the BMS is a primary controller or determined to be the primary controller based upon a comparison of the BMS address with others on the battery busbar, then the BMS proceeds to process 400 as described with respect to FIG. 4.

If the BMS determines that it is not the primary controller, then the BMS calculates a delta value at step 324. The delta value is defined as the difference between the current measured at step 312 and the current limit calculated at step 310. The process 300 then proceeds to step 326, where the BMS transmits the delta value calculated at step 324 and other BMS charge data collected through the process 300 to the BMS considered to be the primary controller. This other charge data may include but is not limited to the current limit associated with the BMS, a power limit associated with the BMS, a voltage limit associated with a BMS, a real time current measurement, a real time power measurement, a real time voltage measurement, a cell minimum temperature, a cell maximum temperature, and a cell average temperature, for example.

Referring now to FIG. 4, a process for operating a primary controller for a battery pack connected to a battery busbar is shown, according to an exemplary embodiment. As mentioned above, any of the battery management systems (e.g., BMS 232, BMS 234, BMS 236, and BMS 238) within the parallel battery management system 200 may become the primary controller. The primary controller is configured to communicate with and serve as the primary communication gateway between the equipment (e.g., the charger) and the other battery packs coupled to the battery busbar. If a BMS is designated as the primary controller BMS at step 322 in process 300, then the primary controller BMS begins the process 400 by receiving charge data from the other battery management systems within the parallel battery system 200. Each BMS on a battery pack that is not designated as the primary controller BMS can be queried for operational and address data by the primary controller BMS. As mentioned above, the operational data or charge data from the battery pack may include but is not limited to whether the battery pack is currently connected to the battery busbar, current limits associated with each respective BMS, a power limit associated with each respective BMS, a voltage limit associated with each respective BMS, a real time current measurement from each BMS, a real time power measurement from each BMS, and a real time voltage measurement from each BMS. The primary controller BMS is configured to receive and store address data and charge data from each battery pack within a local memory. In some examples, the primary controller BMS maintains a table of the ID and address for each BMS associated with the parallel battery system 200. Any charge data received from each BMS associated with the parallel battery system is stored along with the corresponding address and ID of each BMS.

The primary controller BMS then calculates a current limit, a power limit, and a voltage limit output to the charger based on the delta values from the other BMS within the parallel battery system 200 at step 404. Using this data, and at step 406, the primary controller BMS updates charge data tables based on charge data received from each of the other BMS within the parallel battery system 200. Additionally, the primary controller BMS updates the charge data tables with its own charge data. If the charge data received from a BMS within the parallel battery system 200 does not match the ID of the BMS, the primary controller may send the address through the address claiming process to attempt to resolve the identification issue. If a conflict in address is observed, the charge data from the conflicting addresses will not be used until the address is claimed correctly. In some examples, the primary BMS controller then transmits the stored charge data tables to each of the other BMS within the system for storage and update of internal records.

At step 408, the primary controller BMS determines the minimum current limit and minimum current limit delta values from the charge data table. In some embodiments, the BMS may use either a proportional, PI, PD, or PID control loop to determine the current limit output to a charger based on the minimum delta value from the other battery management systems within the parallel battery system 200. The control loop attempts to hold the minimum delta value as close to 0 as possible, which prevents overcharging that might otherwise damage the battery pack. In some embodiments, the control loop from the primary controller BMS slowly increases the current limit for the charger (e.g., by issuing a command from the primary controller BMS to the controller of the charger) and tracks whether the charger output current increases accordingly. If the current limit for the charger is reached, the current limit for the charger is held. The primary controller determines if the current limit has been reached either from communication from the charger or from the lack of increasing output. The primary controller BMS can also adjust various operating features of the charger, including changing an operational mode. For example, the primary controller BMS can command the charger to adjust between an idle state (e.g., no current in), a constant current state, and/or a constant voltage state. In still other examples, the primary controller BMS can communicate software updates for the charger to the controller of the charger. In some embodiments, the primary controller BMS may immediately drop the current limit for the charger to 0 if a sudden increase in current is observed. For example, if a battery pack joins the battery busbar without prior communication to the battery bus, then the primary controller BMS would drop the current limit for the charger to 0, and issue a command to one or more of the secondary BMS within the system to decouple the battery cells from the battery busbar using one or more different communication protocols, as discussed above. In still further examples, the primary controller BMS will communicate with the controller of the charger to cease outputting current upon a detection of a sudden change in current on the battery busbar.

At step 410, the primary controller BMS continues the process 400 by calculating a controller value for the current limit and voltage limit for the charger. In some embodiments, the primary controller is configured to issue a command to the charger controller to transition the charger from constant current mode to constant voltage mode when any BMS reaches the maximum voltage limit. As mentioned above, each of the control loops for the battery management systems associated with the parallel battery system 200 holds the voltage limit by controlling the current limit. Although the current limit output for the charger determined by the primary controller BMS is independent of the current limit received from each of the other BMS within the parallel battery system 200, if the current limit from any of the other BMSs drops to 0, the current limit for the charger will also drop to 0. This allows each parallel battery system to charge as close to the current limit for the charger as possible without exceeding the current limit for the charger.

Referring now to FIG. 5A, a process 500 for ensuring that there is no loss of communication with the primary controller is shown, according to an exemplary embodiment. The process 500 may executed by every BMS (e.g., BMS 232, BMS 234, BMS, 236, and BMS 238), including the primary controller BMS, within the parallel battery system 200 to ensure correct transmission of charge data. At step 502, the primary controller BMS receives charge data. The charge data, as discussed above within process 400, is provided by each of the other battery packs present on the battery busbar within the parallel battery system 200, and includes the battery IDs associated with the charge data. At step 504, the primary controller BMS compares the battery IDs within the received charge data tables with a stored address claim index for the data that was previously received by the primary controller BMS (e.g., during process 300). If the IDs and address claim index don't match, then the primary controller sends the non-compliant address(es) through the address claiming process, shown in additional detail in FIG. 5B.

If the ID and address claim index match, then a loss of communication timer is set to zero at step 506. With the loss of communication timer reset, the primary controller then processes the valid charge data for the ID at step 508. Processing the valid charge data can effectively be performed by overwriting or otherwise storing the validated data within a localized or remote memory that is accessible by the primary controller BMS. The validated data can then be transmitted to the other BMSs on the battery busbar. If the loss of communication timer is not set to zero at step 506 (e.g., because of a discrepancy in address or ID data), the communication timer will continue to run. The loss of communication timer functions to ensure that each BMS within the system continues to provide and receive current data, and runs for a predetermined period of time. If the loss of communication timer achieves a threshold value (e.g., 5 seconds, 15 seconds, 1 minute, 5 minutes, etc.), the primary controller BMS and/or the other BMSs within the system understand that an interruption in communication between one or more batteries has occurred, as ID issues with charging information persist.

At step 510, the primary controller increments the loss of communication timer for the ID. The increments can be on a regular interval, such as 10 ms, for example. As indicated above, the timer is reset upon receipt of valid charge data. If valid charge data is not received, however, the loss of communication timer will expire after reaching a set threshold time limit (e.g., 5 seconds). In the case of the other BMSs which are not the primary controller BMS, if the loss of communication timer expires, the data stored within each BMS will be considered invalid and outdated. In the case of the primary controller BMS, if the loss of communication timer expires, then the first BMS to reach this timer expiration will send an immediate message flagging the loss of the primary controller BMS to the other BMSs within the parallel battery system 200. If communication is lost with the primary controller BMS, the other BMSs within the system proceed to determine a new primary controller BMS that is still in communication with the other battery packs within the system. Then all the BMSs within the parallel battery system 200 reset their IDs, addresses, charge information buffers, and then proceed through the address claiming process as outlined in FIG. 5B.

Referring now to FIG. 5B, an address claiming process 550 for assigning addresses and IDs to each BMS within the parallel battery system 200 is shown, according to an exemplary embodiment. The process 550 provides a conflict resolution action when a second BMS joins the battery bus bar with the same identifying information as another BMS already joined to the battery busbar. At step 512, the address claim for a new BMS joining the battery busbar is received. As discussed previously, the address claim can be based on a variety of features, including battery serial number and manufacturer, among other features. At step 514, the BMS determines if an address match exists. If the address match does not exist, then the BMS updates its address claim index with a new value at step 516 and then calculates an ID for the BMS at step 522. If the address match does exist, then the BMS determines whether there is an ID match at step 518. If an ID match exists, then an ID is calculated for the BMS at step 522. If an ID match does not exist, the BMS executes an arbitration at step 520 before calculating an ID for the BMS at step 522. This arbitration is done by incrementing a calibratable parameter within the arbitration data to resolve the conflict. In some embodiments, the calibratable parameter which can be used to resolve a conflict may be set manually by the user with a diagnostic calibration tool to pre-determine the address claim sequence of multiple BMSs. In some embodiments, each BMS within the parallel battery system 200 resets its address claim information to prevent recurrent errors or storing an address which has since been updated.

The various methods and systems described herein may allow battery systems in various types of equipment (e.g., outdoor power equipment, indoor power equipment, portable jobsite equipment, military vehicle applications, etc.) to utilize parallel battery packs in a way that prevents damage to individual battery packs when battery packs attempt to join a system in a parallel configuration. The methods and systems described herein also provide a parallel battery system that has robust communication that can readily adjust in case of a temporary or permanent communication loss occurring within the various battery management systems mentioned in the present disclosure. Each battery pack and BMS can be configured to transmit charge data and other information to other batteries and/or charger stations and equipment using physical serial interfaces or OTA interfaces, and will supply data having a unique identification that allows for easy tracking of the charging information. Each BMS within the system can then assume the role of primary controller in the event of a loss of communication with one or more battery packs on the system, which might occur when one or more batteries is suddenly removed from the charger station, while others remain connected to the battery busbar.

While this specification contains many specific implementation details, these should not be construed as limitations on the scope of what may be claimed, but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub-combination or variation of a sub-combination.

It should be understood that while the use of words such as desirable or suitable utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” or “at least one” are used there is no intention to limit the claim to only one item unless specifically stated to the contrary in the claim.

It should be noted that certain passages of this disclosure can reference terms such as “first” and “second” in connection with side and end, etc., for purposes of identifying or differentiating one from another or from others. These terms are not intended to merely relate entities (e.g., a first side and a second side) temporally or according to a sequence, although in some cases, these entities can include such a relationship. Nor do these terms limit the number of possible entities (e.g., sides or ends) that can operate within a system or environment.

The terms “coupled” and “connected” and the like as used herein mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another or with the two components or the two components and any additional intermediate components being attached to one another.

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicably coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively, or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively, or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

1. A battery pack assembly, comprising:
a battery pack, comprising:
a housing receiving a plurality of rechargeable battery cells;
a battery management system (BMS) in communication with the rechargeable battery cells and configured to monitor one or more operating characteristics of the rechargeable battery cells;
a plurality of terminals extending outward from the housing and in electrical communication with the rechargeable battery cells to transmit electrical power between the rechargeable battery cells and a piece of equipment coupled with the plurality of terminals;
a communication interface in communication with BMS and configured to transmit the operating characteristics of the rechargeable battery cells over a communication protocol and receive information from the piece of equipment coupled with the plurality of terminals over the communication protocol; and
wherein the BMS is configured to determine a current limit of the battery pack based upon a maximum cell voltage of the rechargeable battery cells and adjust an input current of electrical power through the plurality of terminals to the rechargeable battery cells to adjust a current received by the battery pack toward the current limit.

2. The battery pack assembly of claim 1, wherein the BMS is configured to use at least one of a proportional, proportional integral, proportional derivative, and proportional integral derivative control loop to determine the current limit of the battery pack based upon the maximum cell voltage of the rechargeable battery cells and transmits a command through the communication interface to adjust an input current request for electrical power through the plurality of terminals based upon the determined current limit of the battery pack.

3. The battery pack assembly of claim 1, wherein the operating characteristics of the rechargeable battery cells include at least one of a rechargeable battery cell temperature, a rechargeable battery cell voltage, a rechargeable battery cell voltage limit, and a cell current limit look up table.

4. The battery pack assembly of claim 1, wherein the piece of equipment is a battery charger, and wherein the BMS is configured to communicate the current limit of the battery pack to the battery charger over the communication protocol to adjust an output parameter of the battery charger, wherein the output parameter is configured to adjust the current received by the battery pack toward the current limit.

5. The battery pack assembly of claim 1, wherein the BMS is configured to calculate a delta value of the battery pack using the input current and the input current limit and communicate the delta value of the battery pack to the piece of equipment over the communication protocol, wherein the delta value is configured to adjust the current received by the battery pack toward the current limit to reduce the delta value.

6. The battery pack assembly of claim 1, wherein the BMS is a first BMS, and wherein the battery pack assembly further comprises a second battery pack having a second BMS, wherein the first BMS is configured to transmit operational characteristics from the second battery to the piece of equipment over the communication protocol.

7. The battery pack assembly of claim 6, wherein the second BMS is configured to transmit operational characteristics from the first battery to the piece of equipment over the communication protocol.

8. The battery pack assembly of claim 1, wherein the BMS is configured to output an identification number of the battery pack over the communication protocol.

9. The battery pack assembly of claim 1, wherein the communication protocol is controller area network bus (CANbus).

10. The battery pack assembly of claim 1, wherein the communication protocol is an over-the-air protocol.

11. A battery pack assembly, comprising:
a battery charger having a controller configured to adjust an output of the battery charger;
a battery pack comprising:
a plurality of rechargeable battery cells;
a battery management system (BMS) in communication with the plurality of rechargeable battery cells and configured to monitor one or more operating characteristics of the plurality of rechargeable battery cells;
a plurality of terminals in electrical communication with the plurality of rechargeable battery cells and configured to couple with the battery charger to receive and supply electrical power from the charger to the plurality of rechargeable battery cells; and
a communication interface in communication with the BMS and configured to communicate with the controller over a communication protocol;
wherein the controller is configured to adjust the output of the battery charger upon receiving an indication from the BMS, over the communication protocol, that an input current from the battery charger is less than an input current limit of the battery pack.

12. The battery pack assembly of claim 11, wherein the battery charger includes a battery bus configured to electrically couple with the battery pack and another battery pack in a parallel configuration.

13. The battery pack assembly of claim 12, wherein the controller is configured to adjust an operational mode of the battery charger in response to receiving a signal from the battery pack that the input current limit of the battery pack is equal to zero.

14. The battery pack assembly of claim 11, wherein the battery pack is configured to communicate operational characteristics of a second battery pack coupled to the battery charger using the communication protocol, wherein the controller is configured to adjust the output of the battery charger upon receiving an indication of the operational characteristics of the second battery pack from the first battery pack.

15. The battery pack of claim 11, wherein the BMS is configured to determine the input current limit of the battery pack using a maximum cell voltage of the rechargeable battery cells.

16. The battery pack of claim 11, wherein the communication protocol is an over-the-air protocol.

17. The battery pack of claim 11, wherein the BMS is configured to monitor a temperature of the rechargeable battery cells, wherein the controller is configured to adjust the output of the battery charger upon receiving an indication from the BMS, over the communication protocol, that the temperature of the rechargeable battery cells exceeds a threshold temperature.

18-20. (canceled)

21. A battery system, comprising:
a battery charger electrically connected to a battery busbar;
a first battery pack;
a second battery pack; and
a battery management system (BMS) in communication with the battery charger, the first battery pack, and the second battery pack, the BMS being configured to:
assign a battery ID to the first battery pack and the second battery pack when the first battery pack and the second battery pack attempt to join the battery busbar;
determine, based on the battery ID of the first battery pack and the second battery pack, if the first battery pack or the second battery pack is a primary battery pack;
receive, from the primary battery pack, charge data from the first battery pack and the second battery pack;
calculate limit data for the first battery pack and the second battery pack; and
control, based on comparing the limit data to the charge data, an output of the battery charger to the battery busbar.

22. The battery system of claim 21, wherein the battery management system is configured to store the charge data and the battery ID of the first battery pack and the second battery pack in a charge data table.

23. The battery system of claim 22, wherein the battery management system is configured to reassign, in response to determining that the charge data for the first battery pack or the second battery pack does not match the battery ID associated with the first battery pack or the second battery pack, the battery ID of the first battery pack and the second battery pack.
